(19) United States
(12) Patent Application Publication
(10) Pub. No.: US 2026/0252416 A1
(43) Pub. Date: Aug. 27, 2026

(54) ARTIFICIAL INTELLIGENCE SYSTEM PROVIDING EVENT ENTERTAINMENT NOTIFICATIONS FOR OVERLAPPING LIVE EVENTS

(71) Applicant: INTERNATIONAL BUSINESS MACHINES CORPORATION, Armonk, NY (US)

(72) Inventors: Arnold DE WOLF, Piotrowka (PL); Jennifer M. HATFIELD, Portland, OR (US); Jeremy R. FOX, Georgetown, TX (US); Aaron Keith BAUGHMAN, Cary, NC (US)

(21) Appl. No.: 19/063,401

(22) Filed: Feb. 26, 2025

(51) Int. Cl. G06F 9/54; G06N 20/00; H04N 21/45

(52) U.S. Cl. CPC G06F 9/542; G06N 20/00; H04N 21/4532

(57) ABSTRACT

An artificial intelligence-based method is provided which includes training a machine learning ratings model using event-related data to predict entertainment value ratings for live events to be provided across one or more networks, and identifying a collection of live events overlapping, at least in part, in time. Further, the method includes obtaining collection-related data and executing the machine learning ratings model using the collection-related data to predict respective entertainment value ratings for the live events of the collection of live events. Further, the method includes generating an event entertainment notification for the collection of live events based on the respective entertainment value ratings, and transmitting, via one or more application program interfaces, the event entertainment notification for the collection of live events to an electronic device of a user to facilitate initiating an action based thereon.

### BACKGROUND

One or more aspects relate, in general, to enhanced computer-based predictive systems and methods, and more particularly, to an artificial intelligence system and method with a trained machine learning ratings model to facilitate predicting entertainment value ratings for a collection of overlapping live events to be provided across one or more networks.

A variety of computer-based recommendation systems exist for providing data analysis-based recommendations for products to users, for instance, based on user preferences. For example, available recommendation systems can collect data about a user, such as browsing history and/or purchase history, and apply artificial intelligence to analyze the data and identify patterns from which a prediction can be made to suggest, for instance, another relevant product to the user.

### SUMMARY

Certain shortcomings of the prior art are overcome, and additional advantages are provided herein through the provision of a method which includes training a machine learning ratings model using event-related data to predict entertainment value ratings for live events to be provided across one or more networks, where the event-related data includes in part different event-related data types. In addition, the method includes identifying, by an artificial intelligence system, a collection of live events overlapping, at least in part, in time, and obtaining collection-related data, where the collection-related data includes event-related data for the live events of the collection of live events. Further, the method includes executing, by the artificial intelligence system, the machine learning ratings model using the collection-related data to predict respective entertainment value ratings for the live events of the collection of live events, and generating, by the artificial intelligence system, an event entertainment notification for the collection of live events based on the respective entertainment value ratings. Further, the method includes transmitting, via one or more application program interfaces, the event entertainment notification for the live events of the collection of live events to an electronic device of a user to facilitate initiating an action based thereon.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2A depicts one embodiment of a computer program product with event entertainment processing code, in accordance with one or more aspects of the present disclosure;

FIG. 2B depicts one embodiment of event entertainment notification update code of an event entertainment processing code, such as the event entertainment processing code of FIG. 2A, in accordance with one or more aspects of the present disclosure;

FIG. 2C depicts one embodiment of personalize event entertainment notification code of an event entertainment processing code, such as the event entertainment processing code of FIG. 2A, in accordance with one or more aspects of the present disclosure;

FIG. 2D depicts one embodiment of feedback data retrain model code of an event entertainment processing code, such as the event entertainment processing code of FIG. 2A, in accordance with one or more aspects of the present disclosure;

FIG. 3A depicts one embodiment of event entertainment processing, in accordance with one or more aspects of the present disclosure;

FIG. 3B depicts one embodiment of generating an updated event entertainment notification within an event entertainment process, such as the event entertainment process of FIG. 3A, in accordance with one or more aspects of the present disclosure;

FIG. 3C depicts one embodiment of personalizing event entertainment notification based on user-affinities within an event entertainment process, such as the event entertainment process of FIG. 3A, in accordance with one or more aspects of the present disclosure;

FIG. 3D depicts one embodiment of retraining machine learning (ML) ratings model based on feedback data within an event entertainment process, such as the event entertainment process of FIG. 3A, in accordance with one or more aspects of the present disclosure;

FIG. 4 depicts another example of a computing environment to include and/or use one or more aspects of the present disclosure;

FIG. 5 depicts one example of machine learning model training, in accordance with one or more aspects of the present disclosure;

FIGS. 6A & 6B depict one embodiment of a power index determination process and an ELO score determination process, respectively, in accordance with one or more aspects of the present disclosure;

FIG. 7 depicts a further example of a computing environment to include and/or use one or more aspects of the present disclosure; and

FIG. 8 depicts a further embodiment of an event entertainment process workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, tools, engines, etc. One or more aspects of an illustrative embodiment can be implemented in software, hardware, or a combination thereof.

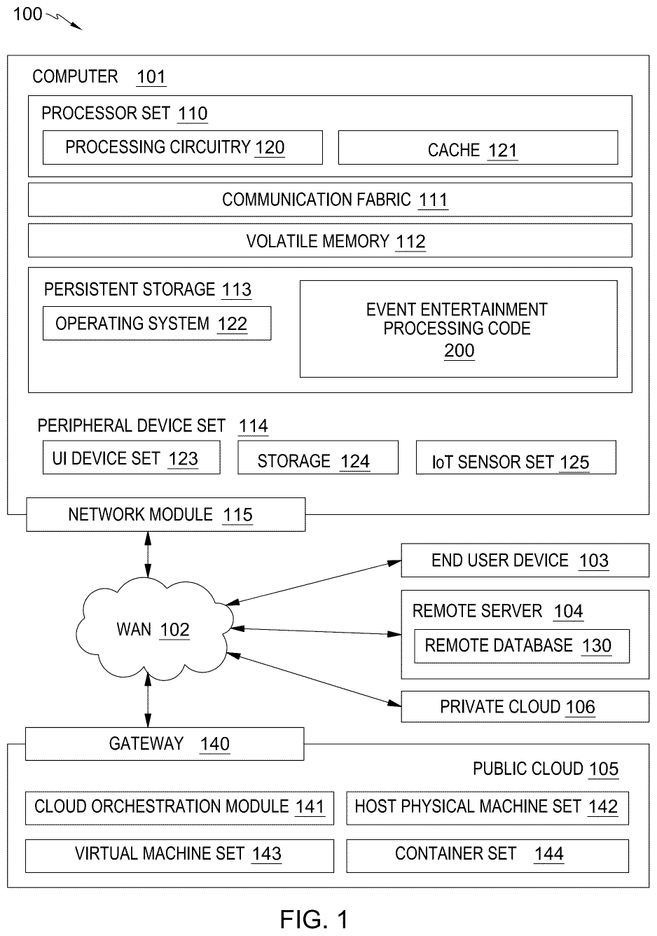

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as code, or one or more programs, are depicted in FIG. 1, including operating system 122 and event entertainment processing code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as event entertainment processing code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in data-analytics-based event entertainment processing code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

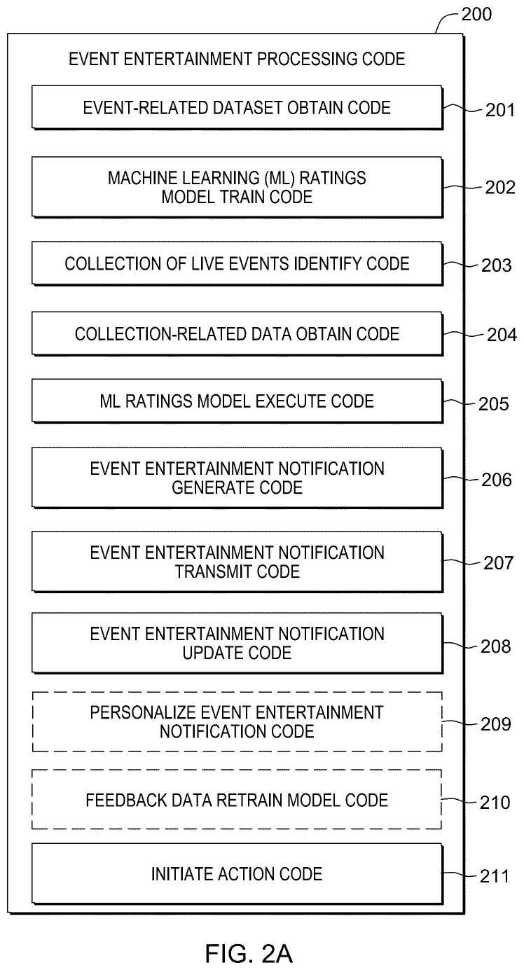

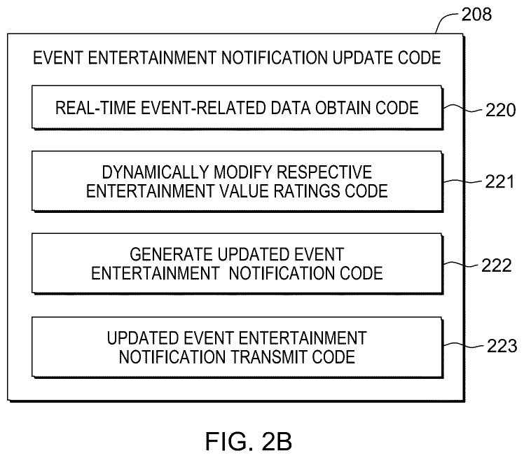

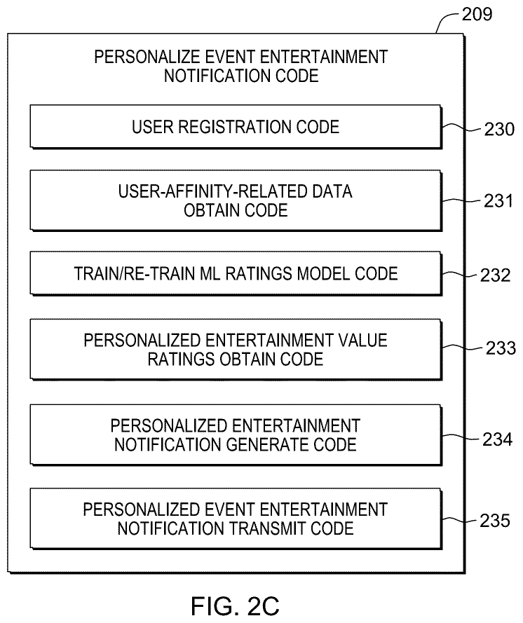

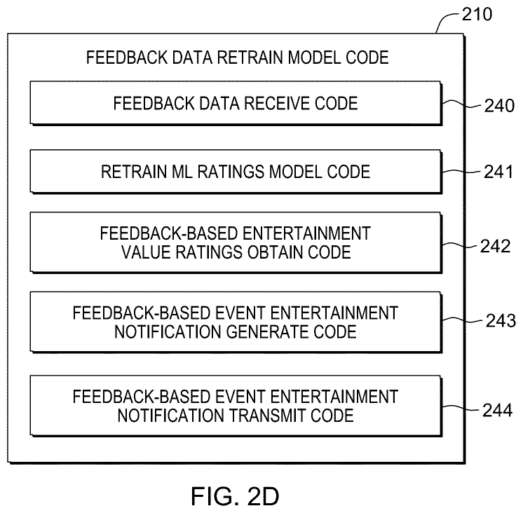

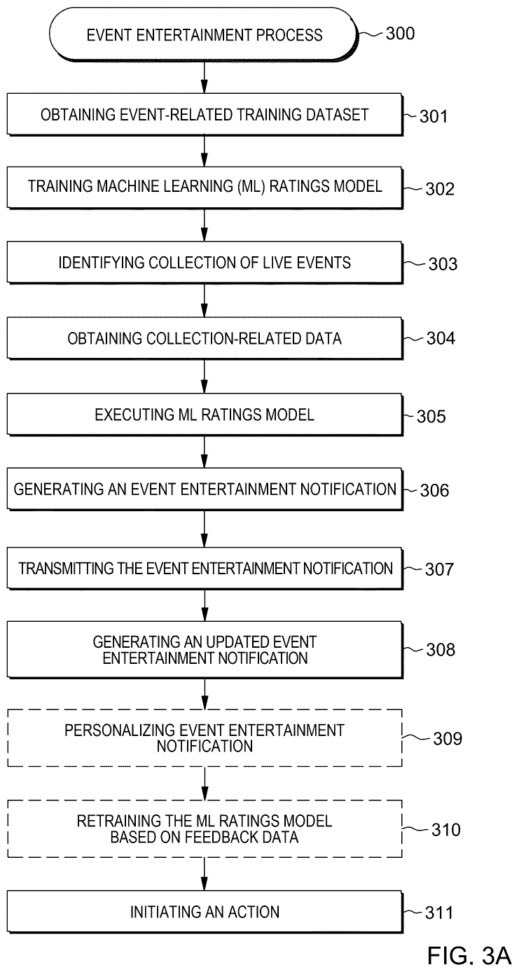

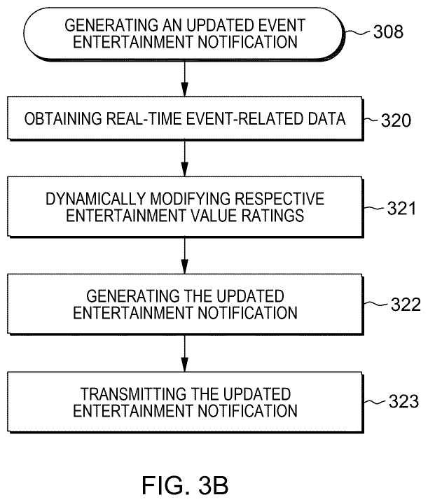

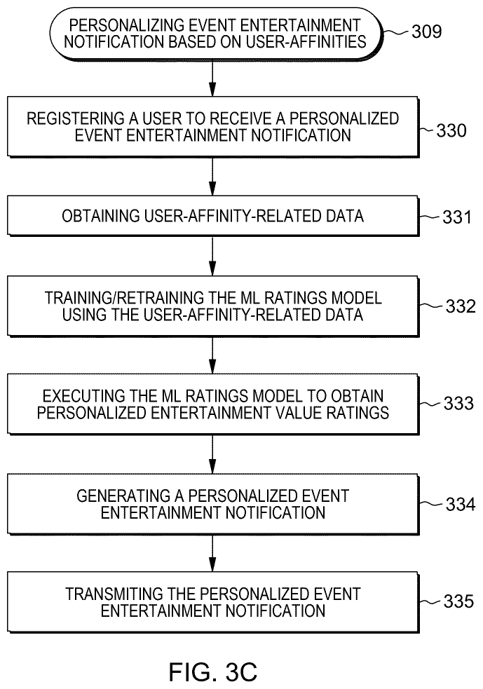

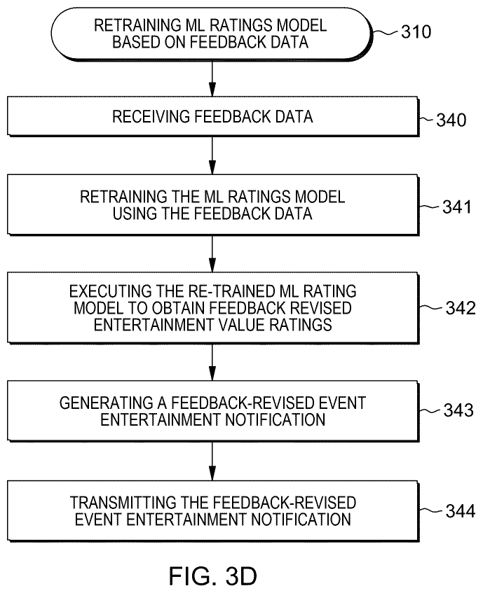

By way of example, one or more embodiments of the event entertainment processing code and workflow are described initially with reference to FIGS. 2A-3D. FIGS. 2A-2D depict one embodiment of event entertainment processing code 200 that includes code or instructions to perform event entertainment processing, including training one or more machine learning ratings models, in accordance with one or more aspects of present disclosure, and FIGS. 3A-3D depict one embodiment of an event entertainment process workflow, including training one or more machine learning ratings models, in accordance with one or more aspects of the present disclosure.

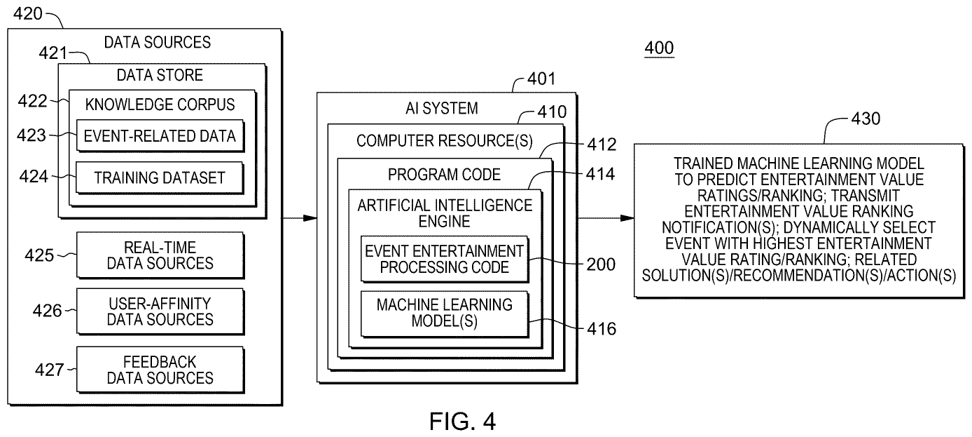

Referring to FIGS. 1-2D, event entertainment processing code 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101 (FIG. 1) and/or computer resource(s) 410 (FIG. 4); one or more processors sets 110 (FIG. 1); processors, such as one or more processors of processor set 110; and/or processing circuitry, such as processing circuitry of processor set 110, etc.

As noted, FIGS. 2A-2D depict one embodiment of event entertainment processing code 200 which, in one or more implementations, includes, or facilitates event entertainment processing in accordance with one or more aspects of present disclosure. As illustrated in FIG. 2A, in one embodiment event entertainment processing code 200 includes, for instance, event-related dataset obtain code 201 to obtain an event-related dataset for use by a machine learning (ML) ratings model train code 202 to train the machine learning ratings model(s) to predict entertainment value ratings for live events to be provided across one or more networks. In one or more embodiments, event entertainment processing code 200 further includes collection of live events identify code 203 to identify, for instance, by an artificial intelligence system from obtained event input data, a collection of live events overlapping, at least in part, in time, and collection-related data obtain code 204 to obtain collection-related data, where the collection-related data includes event-related data for the live events of the collection of the live events. Note that as used herein a collection of live events refers to two or more live events overlapping, at least in part, in time that are being provided or made available across one or more networks, such as from the same or different event providers. Note also that the event providers can be one or more event broadcasters, one or more streaming service providers, etc. Further, in one or more embodiments, a collection of live events can be a collection of live sporting events, of the same event type (e.g., multiple soccer games) or different event types (e.g., different types of sporting events).

In embodiments, event entertainment processing code 200 further includes ML ratings model execute code 205 to execute, by the artificial intelligence system, the machine learning ratings model using the collection-related data to predict respective entertainment value ratings for the live events of the collection of live events, and event entertainment value notification generate code 206 to generate, by the artificial intelligence system, an entertainment notification for the live events of the collection of live events based on the respective entertainment value ratings. For instance, in one or more embodiments, the event entertainment notification can be, or include, an entertainment value ranking notification for the live events of the collection of live events and/or can be, or include, the respective entertainment value ratings for the live events of the collection of live events, by way of example. Alternatively, or additionally, the event entertainment notification generated can be, for instance, a recommendation notification to select or switch to a particular live event of the collection of live events. In embodiments, event entertainment processing code 200 further includes event entertainment notification transmit code 207 to transmit, for instance, via one or more application programming interfaces, the event entertainment notification for the collection of live events to an electronic device of a user, for instance, to facilitate initiating an action based thereon.

In embodiments, event entertainment processing code further includes event entertainment notification update code 208 to facilitate dynamically modifying one or more of the respective entertainment value ratings and generating an updated event entertainment notification for the live events of the collection of live events during occurrence of one or more of the live events, such as described below with reference to FIG. 2B. In embodiments, event entertainment processing code 200 optionally includes personalize event entertainment notification code 209 to generate and transmit a personalized event entertainment notification for the user for the collection of live events based in part on one or more user affinities, one embodiment of which is described below with reference to FIG. 2C. In addition, in one or more embodiments, event entertainment processing code 200 includes feedback data retrain model code 210 to facilitate receiving, by the artificial intelligence system, feedback data related to event entertainment notification for the collection of live events, and retraining the machine learning ratings model, at least in part, using the feedback data, one embodiment of which is described below with reference to FIG. 2D. As illustrated in FIG. 2A, in embodiments, event entertainment processing code 200 can further include initiate action code 211 to facilitate initiating one or more actions related to, or based on, the event entertainment processing and/or based on the event entertainment notification, as described herein.

FIG. 2B depicts one embodiment of event entertainment notification update code 208. As illustrated, in one embodiment, event entertainment notification update code 208 includes real-time event-related data obtain code 220 to obtain real-time event-related data for one or more live events of the collection of live events during occurrence of the one or more live events. Further, event entertainment notification update code 208 includes dynamically modify respective entertainment value ratings code 221 to dynamically modify one or more of the respective entertainment value ratings by, for instance, re-executing, by the artificial intelligence system, the machine learning ratings model using the real-time event-related data to predict updated respective entertainment value ratings for the one or more live events of the collection of live events. In embodiments, event entertainment notification update code 208 further includes generate updated event entertainment notification code 222 to generate an updated event entertainment notification for the collection of live events based, at least in part, on the updated respective entertainment value ratings. Additionally, event entertainment update notification code 208 includes event entertainment notification transmit code 223 to transmit, for instance, via one or more application programming interfaces, the updated event entertainment notification for the collection of live events to one or more electronic devices of one or more users, for instance, to facilitate initiating an action based thereon.

FIG. 2C depicts one embodiment of personalize event entertainment notification code 209. As illustrated, personalize event entertainment notification code 209 includes, in one or more embodiments, user registration code 230 to register a user with the artificial intelligence system to, for instance, receive the event entertainment notification, and in particular, to receive a personalized event entertainment notification based on one or more user affinities relevant to the collection of live events. In one or more embodiments, personalize event entertainment notification code 209 further includes user-affinity-related data obtain code 231 to obtain, by the artificial intelligence system based on the registering of the user, user-affinity-related data representative of one or more user affinities related to the live events of the collection of live events. In addition, personalize event entertainment notification code 209 includes, in one or more embodiments, train/re-train ML ratings model code 232 to train, or re-train, the machine learning ratings model in part using the user-affinity-related data to predict, specific for a particular register user, entertainment value ratings of the live events based (in part) on the one or more user affinities, where the event entertainment notification for the live events is a personalized event entertainment notification for the user for the collection of live events based in part on the one or more user affinities. In embodiments, personalize event entertainment notification code 209 includes personalized entertainment value ratings obtain code 233 to execute, or re-execute, via the artificial intelligence system, the machine learning ratings model using the user affinity-related data to predict entertainment value ratings for the live events based, at least in part, on the one or more user affinities, and personalized event entertainment notification generate code 234 to generate a personalized event entertainment notification for the collection of live events based, at least in part, on the one or more user affinities. In addition, personalize event entertainment notification code 209 of FIG. 2C includes personalized event entertainment notification transmit code 235 to transmit, for instance, via one or more application programming interfaces, the personalized event entertainment notification for the collection of live events to the electronic device of the registered user, for instance, to facilitate initiating an action based thereon.

As noted, FIG. 2D depicts one embodiment of feedback data retrain model code 210. As illustrated, feedback data retrain model code 210 includes, in one or more embodiments, feedback data receive code 240 to receive feedback data related to an event entertainment notification for the collection of live events, such as feedback data from one or more users receiving the event entertainment notification for the collection of live events. In addition, feedback data retrain model code 210 includes, in one embodiment, retrain ML ratings model code 241 to retrain the machine learning ratings model, at least in part, using the feedback data, and feedback-based entertainment value ratings obtain code 242 to re-execute the trained machine learning ratings model using the collection-based related data as well as the feedback data to predict the respective entertainment value ratings for the live events for the collection of live events, based in part on the feedback data. In addition, in one or more embodiments, feedback data retrain model code 210 includes feedback-based event entertainment notification generate code 243 to generate a feedback-based event entertainment notification for the live events of the collection of live events based on the updated respective entertainment value ratings, and feedback-based event entertainment notification transmit code 244 to transmit, for instance, via one or more application programing interfaces, the feedback-based event entertainment notification for the collection of live events to an electronic device of a user, for instance, to facilitate initiating an action based thereon.

Note that although code or sub-modules are described herein, event entertainment processing code 200, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the event entertainment processing code is used, in accordance with one or more aspects of the present disclosure, to perform event entertainment processing. FIGS. 3A-3D depict one example of an event entertainment process 300, or workflow, such as disclosed herein. The process is executed, in one or more embodiments, by a computer (e.g., computer 101 (FIG. 1), computer resource(s) 410 (FIG. 4)), and/or one or more processor sets, such as a processor or processing circuitry (e.g., of processor set 110 of FIG. 1). In one example, code or instructions implementing the process, are part of a code or module, such as event entertainment processing code 200 of FIGS. 1-2D. In other examples, the code can be included in one or more other modules and/or one or more other sub-modules of one or more other modules. Various options are available.

As illustrated in FIG. 3A, in one example, event entertainment process 300 executing on one or more computers (e.g., computer 101 of FIG. 1, computer resource(s) 410 of FIG. 4), one or more processor sets (e.g., processor set 110 of FIG. 1, such as a processor or processing circuitry of the processor set) performs event entertainment value processing such as described herein, which includes, in one or more embodiments, obtaining an event-related training dataset 301 for use in training one or more machine learning (ML) ratings models, and training the one or more machine learning (ML) ratings models 302 using the obtained event-related data training dataset to predict entertainment value ratings for live events to be provided across one or more networks, where the event-related data includes in part different event-related data types. In embodiments, event entertainment process 300 further includes identifying a collection of live events overlapping, at least in part, in time 303. For instance, the collection of live events can be identified by an artificial intelligence system from obtained event input data detailing ongoing and/or upcoming live events, such as live sporting events. In embodiments, event entertainment process 300 further includes obtaining collection-related data 304, where the collection-related data includes event-related data for the live events of the collection of live events.

In embodiments, event entertainment process 300 further includes executing the machine learning (ML) ratings model 305. In one or more embodiments, the executing by the artificial intelligence system, the machine learning ratings model uses the collection-related data and predicts respective entertainment value ratings for the live events of the collection of live events. In embodiments, event entertainment process 300 further includes generating an event entertainment notification 306 for the live events of the collection of live events based on the respective entertainment value ratings, and transmitting, for instance, via one or more application program interfaces, the event entertainment notification for the collection of live events to an electronic device of a user, for example, to facilitate initiating an action based thereon 307.

In embodiments, event entertainment process 300 further includes generating an updated event entertainment notification based on real-time event data 308, one embodiment of which is described below with reference to FIG. 3B. In embodiments, event entertainment process 300 optionally includes personalizing event entertainment notifications based on user affinities 309, an embodiment of which is described below with reference to FIG. 3C, and/or optionally includes retraining the machine learning ratings model based on feedback data 310, one embodiment of which is described below with reference to FIG. 3D. In embodiments, event entertainment process 300 further includes initiating an action 311 in connection with the event entertainment processing and/or based on the generated event entertainment notification.

In one or more embodiments, the action initiated can be any of a variety of actions initiated in connection with the event entertainment processing and/or based on the generated event entertainment notification. For instance, in one embodiment, the action can include sending a prompt or inquiry by the artificial intelligence system to the user electronic device to inquire whether the user wishes to register for system collection of user affinity data to provide personalized event entertainment notifications specific to the user. In another example, the artificial intelligence system can initiate an inquiry or prompt to the user electronic device for feedback data on, for instance, a transmitted event entertainment notification. In one or more other embodiments, the action can be an automatic switching of events being broadcast on a particular channel or streaming service from, for instance, an existing event of the collection of live events to a higher ranked live event of the collection of live events pursuant to the event entertainment notification, such as may be the case where the user is a broadcaster or streaming service provider. In one or more embodiments, the action can be an inquiry or prompt to the user to facilitate identifying the particular collection of live events to be analyzed by the artificial intelligence system. In one or more embodiments, the action can be providing to the user, via the user's electronic device, a user interface with one or more selectable options based on, or to receive, the generated event entertainment notification. In another example, the action can be an inquiry or prompt to the user's electronic device to determine whether the user wishes to switch to a higher ranked live event of the collection of live events. Further, in one or more embodiments, the related action is initiated, or performed, by the artificial intelligence system, such as by a computer (e.g., computer 101 (FIG. 1); computer resources 410 (FIG. 4), a processor of a processor set (e.g., processor set 110), and/or processing circuitry of a processor set (e.g., processor set 110)), of the computing environment, with the computer being part of, or separate from, the artificial intelligence system executing the machine learning ratings model and providing the event entertainment notification, that is, depending on the action. Based on initiating an action, the action is performed. The action can be performed automatically (e.g., using computer code, an electronic device, etc.) and/or manually, depending on the action. Many possibilities exist.

As noted, FIG. 3B depicts one embodiment of generating an updated event entertainment notification 308. In one embodiment, generating the updated event entertainment notification 308 includes obtaining real-time event-related data for one or more live events of the collection of live events during occurrence of the one or more live events 320, and dynamically modifying one or more respective entertainment value ratings 321. Modifying the respective entertainment value ratings can include, for instance, re-executing by the artificial intelligence system, the machine learning ratings model using the real-time event-related data to predict updated respective entertainment value ratings for the one or more live events of the collection of live events. In one or more embodiments, generating an updated event entertainment notification 308 further includes generating the updated entertainment notification 322 for the live events of the collection of live events based, at least in part, on the updated respective entertainment value ratings 322, and transmitting the updated entertainment notification for the live events of the collection of live events to the electronic device of the user 323.

FIG. 3C depicts one embodiment of personalizing an event entertainment notification based on user-affinities 309. As illustrated, in one or more embodiments, personalizing event entertainment notification for the collection of live events based on one or more user-affinities can include registering a user to receive a personalized event entertainment notification 330. For instance, in one or more embodiments, the user can register with the artificial intelligence system and in so doing the system can receive permission from the user to collect user-affinity data. Note that to the extent implementation of aspects of the disclosure collect, store, or employ personal information provided by, or obtained from individuals (for example, viewing preferences, team preferences, player preferences, etc.), such information should be used in accordance with all applicable laws concerning protection of personal information. Additionally, the collection, storage and use of such information may be subject to consent of the individual to such activity, for example, through “opt-in” or “opt-out” processes, as may be appropriate for the situation and type of information. Storage and use of the user-affinity information can be in any appropriate secure manner reflective of the type of information, for example, through various encryption and/or anonymization techniques for confidential or sensitive information.

As illustrated in FIG. 3C, personalizing event entertainment notification based on user-affinities 309 further includes, in one or more embodiments, obtaining user-affinity-related data 331. For instance, based on the user registering, the artificial intelligence system can obtain user-affinity related data representative of one or more user affinities related to the live events of the collection of live events, such as directly from the user and/or by searching the registered user's online presence, including social media, for user-affinity data relevant to one or more live events of the collection of live events, such as favorite teams, sporting events and/or players. Further, personalizing event entertainment notification based on user-affinities 309 includes, in one or more embodiments, training/retraining the machine learning (ML) ratings model using the user-affinity-related data to predict entertainment value ratings of the live events based (in part) on the one or more user-affinities 332, and executing the machine learning ratings mode to obtain personalized entertainment value ratings based in part on the user's affinities 333. In addition, in one or more embodiments, personalizing event entertainment notification based on user-affinities 309 includes generating a personalized event entertainment notification for the live events of the collection of live events based in part on the one or more user-affinities 334, and transmitting, for instance, via one or more application programing interfaces, the personalized event entertainment notification for the collection of live events to an electronic device of the user to facilitate initiating an action based thereon 335.

FIG. 3D depicts one embodiment of retraining the machine learning (ML) ratings model based on feedback data 310. As illustrated, in one or more embodiments, retraining the ML ratings model based on feedback data 310 includes receiving feedback data 340, such as ratings/rankings-related feedback data. For instance, in one or more embodiments, user feedback data can be received by the artificial intelligence system based on a particular event entertainment notification for the collection of live events, such as during occurrence of one or more of the live events, or afterwards. In one or more embodiments, retraining the ML ratings model based on feedback data 310 includes retraining the ratings model using the feedback data 341 and executing the retrained ML ratings model to obtain feedback-revised event entertainment value ratings 342. Further, in one or more embodiments, retraining the ML ratings model based on feedback data 310 includes generating a feedback-revised event entertainment notification 343 and transmitting, for instance, via one or more application programming interfaces, the feedback-revised entertainment notification for the collection of live events to an electronic device of a user, such as to facilitate initiating an action based thereon. In this manner, the artificial intelligence system, and in particular, the machine learning ratings model can dynamically adjust, or learn, based (in part) on the feedback data received, as well as additional event-related data obtained, in one embodiment, as live events occur or after the live events complete.

By way of further example, FIG. 4 depicts another embodiment of a computing environment 400, which can incorporate, use or implement, one or more aspects of an embodiment of the present disclosure. In one or more embodiments, computer environment 400 is implemented as part of or includes, a computing environment such as computing environment 100 described above in connection with FIG. 1. In one or more implementations, computing environment 400 includes an artificial intelligence system 401 with one or more computer resources 410, such as one or more computers 101 of FIG. 1, connected to receive (e.g., obtain, access, etc.) data from one or more data sources 420, such as a data store 421 containing a knowledge corpus 422 with event-related data 423 and/or an event-related training dataset 424. Note in this regard that, in one or more embodiments, event-related data 423 and training dataset 424 can be the same or different datasets, in whole or in part. Further note that, as used herein, event-related data refers to data related to live events to be provided across one or more networks, with the event-related data including in part different event-related types. For instance, where a live event is a sporting event or live game, such as an event played by two or more teams, with each team containing one or more participants, the event-related data can be, or include, participant event-related data, such as historical and/or real-time event-related data for participants of one or more live events of the collection of live events, as well as, for instance, historical and/or real-time game-related data, team-related data, rivalry-related data, standings-related data, trend-related data, etc., relevant to entertainment value of the one or more live events of the collection of live events, with historical data being collected prior to initiation of a particular live event, and real-time data being collected, in one embodiment, commensurate with occurrence of the live event. In one or more embodiments, data sources 420 further include one or more real-time data sources 425, one or more user-affinity data sources 426 and/or one or more feedback data sources 427, each of which can be accessed, or have data provided via, for instance, one or more networks operatively coupling data sources 420 and artificial intelligence system 401.

In embodiments, the one or more computer resources 410 execute program code 412 that runs or implements, for instance, one or more artificial intelligence engines 414 that execute or include one or more aspects of event entertainment processing code 200 (and/or event entertainment process 300), such as disclosed herein. In one or more embodiments, event entertainment processing code 200 trains, or includes, and/or utilizes, one or more machine learning models 416, which can be part of event entertainment processing code 200 or accessed by event entertainment processing code 200. In one or more embodiments, artificial intelligence engine 414 facilitates training the machine learning model(s) 416, such as the machine learning ratings model, using event-related data to facilitate predicting entertainment value ratings for live events to be provided across one or more networks, where the event-related data includes, for instance, different event-related data types, such as described herein. As discussed, artificial intelligence system 401, and in particular, artificial intelligence engine 414, identifies from obtained event input data a collection of live events overlapping, at least in part, in time. In one or more embodiments, the collection of live events can be identified with input data from one or more broadcasters, streaming service providers, etc., and/or from one or more users, or can be defined independent from the broadcasters, providers, users, etc. Further, the event entertainment processing includes obtaining collection-related data, where the collection-related data includes event-related data for the live events of the collection of live events. For instance, the collection-related data can include historical event-related data and/or real-time event-related data depending, for instance, on the timing of the live events of the collection of live events, and the executing of the machine learning ratings model. In embodiments, the artificial intelligence system 401, and in particular, the artificial intelligence engine 414, executes the machine learning ratings model using the collection-related data to predict respective entertainment value ratings for the live events of the collection of live events, and generates therefrom an event entertainment notification for the collection of live events, which is transmitted, for instance, via one or more application programming interfaces, to one or more electronic devices of one or more users, for instance, to facilitate initiating one or more actions based thereon. In one or more embodiments, the user electronic device can include a user interface to, for instance, display the received event entertainment notification for the collection of live events, and to facilitate taking an action based thereon.

In one or more embodiments, once the machine learning ratings model is trained, the event entertainment processing code 200 and/or artificial intelligence engine 414, executes, or initiates executing, the trained machine learning ratings model using the collection-related data to predict respective entertainment value ratings for the live events of the collection of live events. The executing can be performed periodically before and/or during occurrence of the live events of the collection of live events, and/or can be performed on demand, such as at the request of a user. As illustrated, in one or more embodiments, artificial intelligence system 401 can train, reference and/or provide, the machine learning ratings model to predict entertainment value ratings/rankings, can transmit event entertainment value ranking/ratings notifications, can dynamically select a live event with a highest entertainment value rating/ranking, and/or provide one or more other related solutions, recommendations and/or actions. For instance, in one embodiment, an indication can be provided by the system to change the live event being provided to a user based on one or more of the respective entertainment value ratings for the live events of the collection of live events and/or based on the event entertainment notification for the collection of live events. As an example, the indication or notification can be sent by computer resource 410, such as a computer (e.g., computer 101 of FIG. 1), a processor of a processor set (e.g., processor set 110 (FIG. 1)) and/or processing circuitry of a processor set (e.g., processor set 110) (FIG. 1) to a computing or electronic device or component that receives the indication and automatically initiates an action. Alternatively, or additionally, one or more ratings/rankings indications or notifications can be sent directly to a user electronic device that performs the action. Based on initiating an action, the action is performed. Many possibilities exist.

In one or more implementations, computing environment 400 can include, or utilize, one or more networks for interfacing various aspects of computer resource(s) 410, data source(s) 420, as well as one of or more other controllers, components, systems, etc., receiving a notification result, action, instruction etc. 430 of the event entertainment processing code 200, and/or artificial intelligence system 401, in a manner that facilitates the improved computer-based system processing disclosed herein. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including (for instance) training data for one or more machine learning model(s) of the artificial intelligence system, and an output solution, recommendation, action of the event entertainment processing code 200, and/or artificial intelligence system 401, such discussed herein.

In one or more implementations, computer resource(s) 410 house and/or execute program code 412 configured to perform computer-implemented methods in accordance with one or more aspects of the present disclosure. By way of example, computer resource(s) 410 can be a computing-system-implemented resource(s). Further, for illustrative purposes only, computer resource(s) 410 in FIG. 4 is depicted as being a single computer resource. This is a non-limiting example of an implementation. In one or more other embodiments, computer resource(s) 410, which implements one or more aspects of processing such as discussed herein, can, at least in part, be implemented in multiple separate computer resources or systems, such as one or more computer resources of a cloud-hosting environment, by way of example.

Briefly described, in one embodiment, computer resource(s) 410 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the event entertainment processing code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code 412 includes, executes, accesses, etc., artificial intelligence engine 414, with event entertainment processing code 200, and which can train and/or use machine learning models 416 that embody (in part), or are used by, the event entertainment processing code 200. The artificial intelligence engine 414 can be (in part) one or more artificial intelligence (AI) agents or AI tools and/or can include, or use, one or more machine learning models that are pretrained using training data that can include a variety of types of event-related data, collection-related data, user-affinity-data, feedback data, etc. In one or more embodiments, program code 412 executing on one or more computer resources 410 applies one or more algorithms of, for instance, the artificial intelligence engine 414 to generate and train the machine learning model(s) 416, which the program code then utilizes to, for instance, implement one or more aspects of event entertainment processing code 200. In an initialization or learning stage, program code 412 can train the one or more machine learning models 416 using an obtained training dataset to implement, for instance, one or more aspects of the code, functions and/or tools described herein.

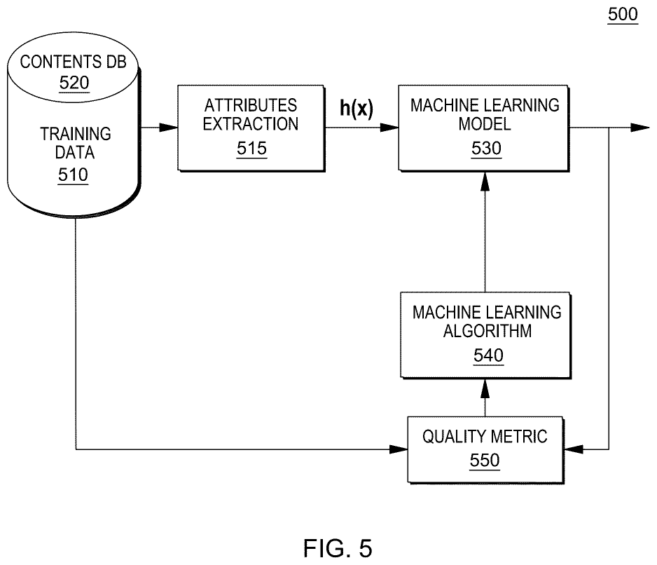

One example of a machine learning training system is depicted in FIG. 5. In one or more embodiments, a machine learning training system 500 can be utilized to perform cognitive analysis of various inputs, including input data, data from one or more sources, repositories, data structures and/or other data. The data can include historical and/or real-time event-related data, collection-related data, user affinity-related data, feedback data, etc., such as described herein. Program code, in embodiments of the present disclosure, can perform data analysis to generate data structures, including algorithms utilized by the program code to implement one or more aspects of the event entertainment processing and/or initiate (or perform) an action related thereto. As known, machine learning-based modeling solves problems that cannot be solved by numerical means alone. In one example, program code extracts features/attributes 515 from the training data 510, which can be stored in memory or one or more databases 520. The extracted features can be utilized to develop a predictor function, h (x), also referred to as a hypothesis, which the program code utilizes as a model 530.

In identifying various event states, features, attribute similarities, constraints and/or behaviors indicative of states in the ML training data 510, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 540 to train the machine learning model(s) 530 (e.g., the algorithms utilized by the program code), including providing weights for the conclusions, so that the program code can train the predictor functions that comprise the machine learning model(s) 530. The conclusions may be evaluated by a quality metric 550. By selecting a diverse set of ML training data 510, the program code trains the machine learning model(s) 530 to identify and weight various attributes (e.g., data attributes, features, patterns, constraints, distributions, etc.) that correlate to various states or events of a process.

The model generated by the program code can be self-learning, since in one or more embodiments, the program code can update the model based on feedback data, as well as from real-time event-related data related to the collection of live events. For example, when the program code determines that there is a constraint, event, similarity or pattern (e.g., data attribute, record attribute similarity, query pattern, data distribution, search terms distribution, etc.) that was not previously predicted by the model, the program code can utilize a learning agent to update the model to reflect the state of the event, in order to improve predictions in the future. Additionally, when the program code determines that a prediction (such as a predicted entertainment value rating) is incorrect, either based on receiving user feedback through an interface or based on monitoring related to the collection of live events, the program code can update the model to reflect the inaccuracy of the prediction for the given period of time. Program code including a learning agent cognitively analyzes any data deviating from the modeled expectations and adjusts the model to increase the accuracy of the model, moving forward.

In one or more embodiments, the program code can utilize one or more neural networks (NNs) to analyze training data and/or collected data to generate an operational machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

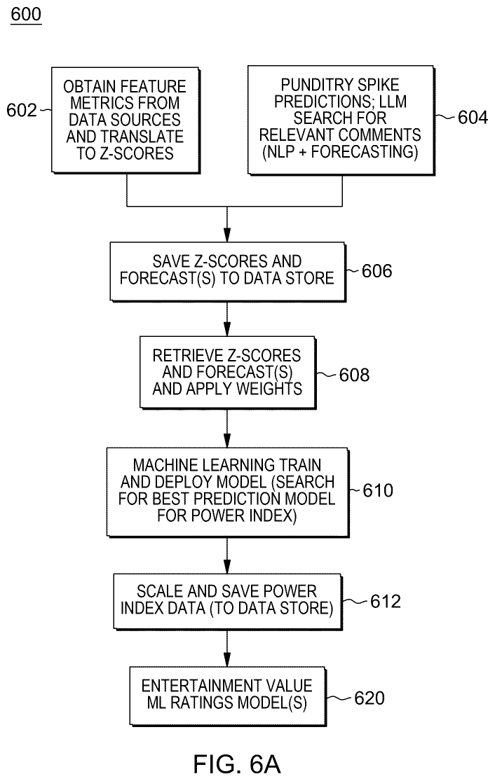

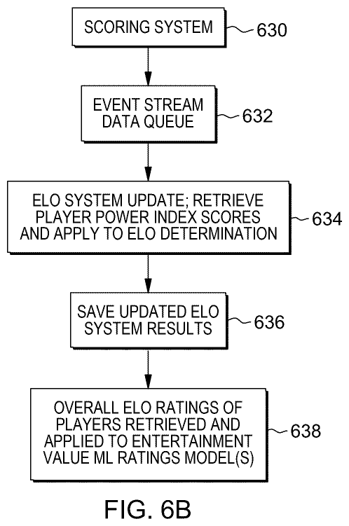

FIGS. 6A-8 further illustrate one or more implementations of event entertainment processing in accordance with one or more aspects disclosed herein. As noted, in one or more aspects, an artificial intelligence system and method are disclosed, which use one or more trained machine learning models, including a trained machine learning ratings model to facilitate predicting entertainment value ratings for a collection of overlapping live events to be provided across one or more networks, and which provide based at least in part thereon, event entertainment notifications to one or more electronic devices of one or more users. On any given weekend there can be a large number of overlapping live events to choose from, such as overlapping sporting events. The artificial intelligence systems and workflows disclosed herein provide event entertainment notifications (or event entertainment value notifications) for overlapping live events that are configured to assist users in identifying the most entertaining (or exciting) event available for a given viewing time window from multiple overlapping live events. For instance, sporting event enthusiasts can face the challenge of choosing which event to watch among a plethora of options across various sports, such as soccer, football, basketball, hockey, etc. With limited time and a desire for engaging entertainment, viewers can struggle to identify the most exciting events, risking disappointment from watching a less thrilling event, while missing out on one or more captivating events. This is particularly an issue on the weekend where multiple live events can be occurring simultaneously. Broadcasters, streaming service providers, mobile application developers, etc., also deal with this issue as they aim to maximize viewer engagement and satisfaction by recommending and showing the most entertaining live events. Without a systematic approach to dynamically evaluating and comparing entertainment value of different live events in real-time, the event providers can struggle to guide viewers effectively. This results in a gap between the availability of live event content and the ability of providers and/or viewers to make informed decisions about what to provide or watch, potentially affecting viewership ratings and revenues.

As noted, disclosed herein are artificial intelligence systems and processes that provide event entertainment notifications for overlapping live events to, for instance, facilitate selecting the most entertaining events to watch from a multitude of live options within any given time window. In one or more aspects, a dynamic, real-time artificial intelligence system and process are provided that assesses and communicates the entertainment value of each event to each unique user, such as to a broadcaster, streaming service provider, mobile application, viewer, etc. As described, in one or more aspects, a dynamic entertainment rating methodology is disclosed that evaluates various live event or live game factors, such as, for instance, participant-related data for participants of the live events of a collection of live events overlapping, at least in part, in time. More particularly, in one or more embodiments, the ascertained event-related data can include, for instance, historical and/or real-time event-related data, such as participant-related data, game-related data, team-related data, rivalry-related data, standing-related data, and/or trend-related data, etc., for the live events. For example, in one embodiment, the event-related data can include team standings, player performance data and historical rivalry data, etc. The event-related data of the collection of live events is used as input when executing a trained machine learning ratings model to predict respective entertainment value ratings for the live events of a collection of live events overlapping, at least in part, in time. Further, in embodiments, the artificial intelligence system generates an event entertainment notification for the collection of live events based on the respective entertainment value ratings and transmits the event entertainment notification for the live events of the collection events to one or more electronic devices of one or more users, for instance, to facilitate initiating one or more actions based thereon. One or more enhancements to the described artificial intelligence system and process are also disclosed herein, including, for instance, integration of real-time input data to the system, providing a personalized notification capability, and providing the system with multi-event type adaptability.

For instance, in one or more embodiments, real-time event-related data for one or more live events of a collection of live events can be obtained during occurrence of one or more of the live events. Using the real-time data, one or more of the respective entertainment value ratings can be dynamically modified and an updated event entertainment notification generated for the live events of a collection of live events during occurrence of the one or more live events. In one or more embodiments, dynamically modifying one or more respective entertainment value ratings can include re-executing, via the artificial intelligence system, the machine learning ratings model using, at least in part, the real-time event-related data to predict updated respective entertainment value ratings for the one or more live events of the collection of live events; and generating the updated event entertainment notification for the collection of live events includes generating the updated event entertainment notification for the collection of live events based, at least in part, on the updated respective entertainment value ratings. Further, in one or more embodiments, the artificial intelligence system transmits the updated event entertainment notification for the collection of live events to one or more electronic devices of one or more users, again in real-time during occurrence of the one or more events of the collection of live events overlapping, at least in part, within a given time interval.

In another embodiment, personalized event entertainment notifications for different users can be generated by the artificial intelligence system and workflow disclosed herein. For instance, in one or embodiments, the personalization aspects can include registering a user with the artificial intelligence system to receive a personalized event notification, and based on the registering, obtaining by the artificial intelligence system, user affinity-related data representative of one or more user affinities related to the live events of a collection of live events overlapping in time. Further, the personalization enhancement can include training the machine learning ratings model in part using the user-affinity-related data to predict entertainment value ratings for the live events based on the one or more user affinities, and generating based on the predicted respective entertainment value ratings a personalized event entertainment notification for the user for the collection of live events. In this manner, an ability is provided to tailor the artificial intelligence system, and in particular, the entertainment value ratings, to individual user affinities, such as to a user's historical viewing habits and/or favorite team(s) or player(s), to generate a personalized event entertainment notification (e.g., a personalized live event recommendation).

In one or more embodiments, multi-event type adaptability can also be provided as part of the artificial intelligence system and workflow. For instance, in one or more embodiments, training the machine learning ratings model using event-related data can include assigning weights to different event-related data types based on predicted impact of the different event-related data types on entertainment value of live events of a collection of live events. For instance, in one or more embodiments, the live events can be live sporting events, such as multiple tennis matches, soccer games, baseball games, basketball games, etc. where the weights applied to the different event-related data types can be based on predicted impact of the respective data type relative to the particular live event at issue (e.g., a tennis match vs. a soccer game). In this manner, the artificial intelligence system and workflow can be adapted for a specific type of live event. Additionally, or alternatively, training the machine learning ratings model can further include training the machine learning ratings model (or models) for different types of overlapping live events to be provided across the one or more networks, where the training includes customizing assigned weights to the different event-related data types based on predicted impact of the different event-related data types on entertainment value of the respective different types of live events. In this manner, the rating criteria of the artificial intelligence system and process can be adapted based on the specific characteristics of the different live event type, providing relative and accurate entertainment ratings across various live event disciplines, and allowing for different types of live events to be part of the same collection of live events, while still providing relevant respective entertainment value ratings for the live events of the collection of live events.

By way of example, in one or more embodiments, the artificial intelligence systems and processes disclosed herein can receive a multitude of event-related input data, such as live event data, including scores, participant performance, significant in-game events, team rankings, historical performance statistics, player ratings based on past and current performances, as well as viewer preferences and historical viewing data. With this input, the artificial intelligence systems and processes disclosed dynamically rate the entertainment value of the live events of the collection of live events in real-time. Further, in one or more embodiments, the systems and processes disclosed adapt to different types of live events, such as different types of sporting events, considering their unique data points and viewer preferences. In addition, the systems and processes disclosed can utilize one or more methodologies, including one or more machine learning models, that process the event-related data input, such as live event data, team statistics and historical rivalries, and provide views with personalized event entertainment notifications, thereby enhancing the user's viewing experience. Advantageously, in one or more embodiments, the systems and processes output real-time entertainment ratings for on-going live events, as well as customized event recommendations tailored to user affinities and updated entertainment value ratings reflecting changes in the live events.

Those skilled in the art will understand that a variety of different types of event-related data or data points can be ascertained and used, in training one or more machine learning rating models, and/or in executing a trained machine learning rating model, such as described herein. As noted, in one or more embodiments, one or more of event-related data can be, or include, participant-related data, game-related date, team-related data, rivalry-related data, standings-related data, and/or trend-related data, etc. In embodiments, the participant-related data can be historical data representative of each participant (or player), which can be used to obtain a rating based on past performance, where with the ratings of the participants on a team, an average rating for the team can be ascertained. Game-related data can include data relating to significance of the particular live event to one team, or both teams, such as whether one or both teams are playing to win a title or make the playoffs, etc. Team-related data can be data related to ranking of a team in a live event, such as based on current competition standings. In one or more embodiments, a higher ratings score can be generated where the teams in a live event are closer to each other in ranking. Rivalry-related data can also be used, such as whether the teams in a particular live event are from a same geographic location, or based on history have a high rivalry rating. Standings-related data can include, for instance, performance of the participating teams over the last x number of live events (such as the last 1-10 games), which can also factor in (depending on the sporting event type) how many goals a particular team scored versus how many goals the team conceded. Trend-related data for the live events in a collection of live events can include, for instance, percentage of wins a team has in the last y number of games (e.g., last 5-10 games) played by each team, which can be a good indication of whether a team is playing in good form, with the better the form, the better the performance that can be expected, and thus, the better the entertainment value of the particular live event. Those skilled in the art will note that many more event-related data inputs can be used as part of predicting respective entertainment value ratings for live events of a particular collection of live events, such as described herein. In one or more embodiments, different live event types (e.g., different sporting event types) can have different event-related data inputs to the machine learning ratings model, as appropriate for the particular live event type.

As specific examples, based on past performance, participant-related data can be used by the artificial intelligence system to generate respective ratings based on past performance of each participant on the teams of a live event, with team-related data being obtained by determining, for instance, an average of all rating scores of the team participants anticipated to play the live event. The game-related data can include, for instance, data representative of what each team in a live event is playing for. For instance, if a team in a live event is playing for a title, they might receive a 100% data score, while a team playing for a higher position in the playoffs might receive a 90% data score, and a team having nothing to play for being assigned, for instance, a 0% score. The team-related data can comprise ranking-related data for the teams in a competition, with each team ranking being ascertained from, for instance, historical data based on past performance. Further, rivalry-related data can be ascertained by determining a rivalry score based, for instance, on historical data from prior events the teams have played. The standings-related data can include data on the standings of the teams in a live event and/or other standings-related data including, for instance, total goals scored or conceded, depending on the event at issue. The standings-related data can be taken over any desired number x of live events, such as the last 1-10 games. For instance, in one embodiment, the data can be derived from the last five games played by each team. The trend-related data for the live events of a collection of live events can be ascertained, in one or more embodiments by referencing the last y number of live events played by each team (e.g., the last 5-10 games) and assigning, for instance, a 100% data score for a win, a 50% data score for a draw or tie, and a 0% data score for a loss, and then averaging the total over the y number of games. As noted, other event-related data inputs can also, or alternatively, be ascertained and used depending on the particular live event type. As an example, in one or more embodiments, the artificial intelligence system is configured to predict respective entertainment value ratings for a particular live event of a collection of live events by, for instance, comparing the respective participant-related data items, game-related data items, team-related data items, rivalry-related data items, standings-related data items and/or trend-related data items, etc. (in one embodiment) to derive a ratings score for that live event of the collection of live events. Once derived, the respective ratings can be ranked with, for instance, the live event of a collection of live events having a highest entertainment value ranking being the live event being recommended by the artificial intelligence system, for instance, in the event entertainment notification that is generated and transmitted to the user electronic device.

A variety of approaches can be used to document the event-related data used, for instance, in training the machine learning ratings model and/or in executing the machine learning ratings to predict respective entertainment value ratings for the live events of the collection of live events. For instance, a standard score or z-score can be used, which indicates how many standard deviations a value is from the mean. In particular, a standard score represents the number of standard deviations by which a value of a raw score (e.g., an observed value or data point) is above or below the mean value observed or measured. In one or more embodiments, participant or player event-related data, such as a decimal grade, evaluation, position, rank, season long projection, percent started, etc., can be used dependent on the event type. Once z-scores or standard scores have been obtained, the scores can be ranked since the values are then comparable. In the following code, ‘sentence features’ or feature values can be obtained and used in determining mean and standard deviation values to facilitate obtaining z-scores for a variety of different types of participant-related data.

for (let index in SENTENCE_FEATURES){
if (playerdata[‘SCORING_PERIOD’]==1 &&
SENTENCE_FEATURES[index].includes(‘_act’)){
continue;
}
let z_score = (playerdata[SENTENCE_FEATURES[index].toUpperCase( )] −
featurestats[SENTENCE_FEATURES[index]+‘_mean’])/featurestats[SENTENCE_FEATURES[
index]+‘_std’]
if (SENTENCE_FEATURES_DIRECTION[SENTENCE_FEATURES[index]]==“ascending”){
z_score = z_score * −1
}
feature_ranks[SENTENCE_FEATURES[index]]=z_score
}

Further, in one or more embodiments, an Elo score can be ascertained, which refers to a numerical rating system used to measure a player's skill. The score is used to indicate a player's relative strength compared to others based on prior games. In one or more embodiments, the standardized scores can be combined together with an Elo score. For instance, the value of a participant or player can be ascertained, in one embodiment, by weighting (wᵢ) the standard scores (vᵢ) obtained for one or more participants of a live event of a collection of live events, such as set forth below in Equation 1, to ascertain a game value (Gameᵥₐₗᵤₑ) for a particular participant or player. In one or more embodiments, the weights can be determined by, for instance, one or more subject matter experts or by correlation between the respective z-scores and some other metric (e.g., a correlation to winning) to arrive at a weight for that particular z-score value.

$$G a m {e}_{ν a l u e} ( \overline{w} , \overline{v} ) = {Σ}_{i}^{I} {w}_{i} {v}_{i} \qquad Eq . 1$$

Additionally, a power index (pi_{p,r}) for a particular player (p) in a particular round (r) or game can be ascertained using, for instance, Equation 2 where wpi_{p,r} represents an artificial intelligence (AI) ascertained power index for the player for the given round.

$$p {i}_{p , r} = 1400 * \frac{log ( {wpi}_{p , r} ) + 5}{5} \qquad Eq . 2$$

For instance, in one or more embodiments, wpi is an AI powered ranking system that provides a power index for each player by, for instance, taking the relative z-scores of the event-related data for the player, summing them and ranking players based on the summations. Equation 2 represents one equation that can be used to translate, for instance, a z-score into a power index value for a given participant. Those skilled in the are will note that the power index, as used herein, is a predictive rating for the participant based, for instance, on historical data of the participant's performance. For instance, in one or more embodiments, the AI driven power index system can be an artificial intelligence system that analyzes large amounts of data, including statics, media commentary, social sentiment, etc., to generate a player ranking for a particular sporting event or game, which is unlike traditional rankings which relay more heavily on historical data. The power index value can be used to prioritize rates of performance and momentum to identify players who are performing particularly well at the moment.

Equations 3 and 4 below facilitate determining an Elo biased power index value (pi_{elo,px,r}) for player px and round or game r by determining, for instance, the odds that player x (px) beats player y (py) in the event (e.g., such as a tennis match).

$${pi}_{elo , px , r} = {pi}_{elo , px , r - 1} + k ( {t}_{px , py} - {Pr}_{x} ( {p}_{x} {beatsp}_{y} ) ) \qquad Eq . 3$$

$${Pr}_{x} ( {p}_{x} {beatsp}_{y} ) = \frac{1}{1 + 10 \frac{( {pi}_{elo , py , r} - {pi}_{elo , px , r} )}{700}} \qquad Eq . 4$$

As indicated in Equation 4, the power index scores can be used to predict whether player x beats player y in the upcoming game. Note that in Equation 3 the variable t_{px,py} is a lookup table or data structure which stores past performance of the players, including player x and player y, from any prior games between, or involving, the two. In this manner, the Elo score can be ascertained using Equations 3 & 4. Note with respect to Equation 3 that pi_{elo,px,r-1} is the power index value for the prior round (r−1) or prior game for player x of the sporting event. Note also that in determining the probability the px beats py, the value “700” is chosen since the value “1400” was initially used in Equation 2, as an arbitrary example. Note further that the power index of Equations 1-4 is related to the values that were obtained for the different attributes or features of the participants or players used in the z-score or standard score processing.

Based on the above, a total value for a participant in a live event, such as a sporting event, can be ascertained, such as indicated in Equation 5. For a live event, such as a live sporting event with multiple participants on each team, the total value based on participant-related data can be obtained by adding each player's game value.

$$T o t a {l}_{ν a l u e} ( G a m {e}_{ν a l u e} ( \overline{w} , \overline{v} ) ) = p {i}_{e l o , px , r - 1} \qquad Eq . 5$$

Note that in one or more embodiments, the Elo score can be adjusted with large language model (LLM) similarity data analysis based on the relevant player biographies and/or a summary of prior game performances. In this manner, the Elo score can be personalized for each player or participant in the event. For instance, the personalized value can be pi_{elo,px,r-1}*(1/(1+PPL (bio, summary))), where the value (1+PPL (bio, summary)) is a perplexity score ascertained to personalize the power index score. For example, the perplexity value can be the output of a machine learning model using, for instance, the participant's biography and an instruction to summarize the event or game. In one or more embodiments, the large language model evaluates text-based data on the participant's biography and/or summaries of prior events to ascertain performance. A standard perplexity Equation can be used to ascertain the resultant value. Note that in this regard, the perplexity can be used to evaluate and identify any surprise values based on the player biographies and recent performances and/or based on prior audience review of prior events or games involving the same players. In this manner, perplexity can be evaluated based on the participants, as well as based on prior reviews of the users or audience members for previous live events.

Note that the above discussion regarding event-related data, and in particular participant-related data, for a live event of a collection of live events represent one or more embodiments only of evaluating ascertaining data, which can be used as event-related data for either training a machine learning ratings model to predict entertainment value ratings for live events to be provided across one or more networks, and/or for executing by an artificial intelligence system the machine learning ratings model to predict entertainment value ratings for the live events of the collection of live events, such as described herein. By way example, FIGS. 6A-6B depict artificial intelligence system processing embodiments for ascertaining event-related data for use as described herein, including for use in predicting respective entertainment value ratings for the live events of the collection of live events overlapping, at least in part, in time. Those skilled in the art will note that FIGS. 6A & 6B each represent one embodiment only for obtaining event-related data for an artificial intelligence system to provide event entertainment notifications for the live events, such as described herein.

In FIG. 6A, one embodiment of artificial intelligence system code processing for determining a power index 600 is presented, which includes program code to obtain feature metrics from one or more data sources and translate the metrics to z-scores 602, which can be accomplished, in one embodiment, such as described above in connection with Equations 1-5. In addition, the artificial intelligence system program code can determine any punditry spike predictions by, for instance, large language model (LLM) searching of the Internet for relevant comments, such as on a participant, team, event, etc., 604. In one or more embodiments, the punditry spike prediction processing can use natural language processing (NLP) as well as forecast processing to forecast forward relevant data. The ascertained z-scores and predictions are saved to a data store 606, and subsequently retrieved by the artificial intelligence system, where weights are applied 608 based, for instance, on the particular event-related data and its impact on predicting entertainment value ratings for the live event. In one or more embodiments, the processing includes machine learning training and deploying of a model to search for and identify a best prediction model for determining the power index 610. In one or more embodiments, training the machine learning model to identify the best prediction model can use a similar process to the processing of FIG. 5, which is described herein in connection with training the machine learning ratings model. Once the machine learning power index model is trained and deployed, the power index data can be ascertained, and scaled and saved to a data store 612 for subsequent retrieval by the artificial intelligence system 620, for use in training the machine learning ratings model and/or in predicting respective entertainment value ratings of the live events of the collection of live events using the trained machine learning ratings model. Note that, in one or more embodiments, a plurality of z-score values can be obtained for each participant of a live event by evaluating a variety of aspects of the participant-related data to create the features of the z-scores, which are then used in one embodiment with the Elo score, such as described above. In one or more embodiments, parallelization in deriving participant-related data can be used to enhance the processing to obtain a plurality of z-scores for each participant or player.

As illustrated in FIG. 6B and described above, the power index scores or standardized scores can be integrated, in one or more embodiments (where desired), with an Elo score to provide, for instance, enhanced participant-related data for use by the machine learning ratings model, such as described. In one embodiment, a scoring system 630 provides event stream data into a queue 632, which can then be used by an Elo-based system or process to update the event-related data by, for instance, retrieving the relevant player power index scores and applying to the scores one or more Elo determinations 634. The updated Elo system results can then be saved 636, with the overall Elo-based data for the participants or players of a live event being subsequently retrieved and applied to the machine learning ratings model(s) 638, such as described herein, in determining entertainment value of the particular live events of a collection of live events. As noted, a scoring approach such as described above, including z-score standardization, adapts to the unique characteristics and data points of different event types (e.g., different types of sports). This ensures that the entertainment value ratings are relevant and accurate for each type of event, and allows for entertainment value ratings between different types of events to be compared.

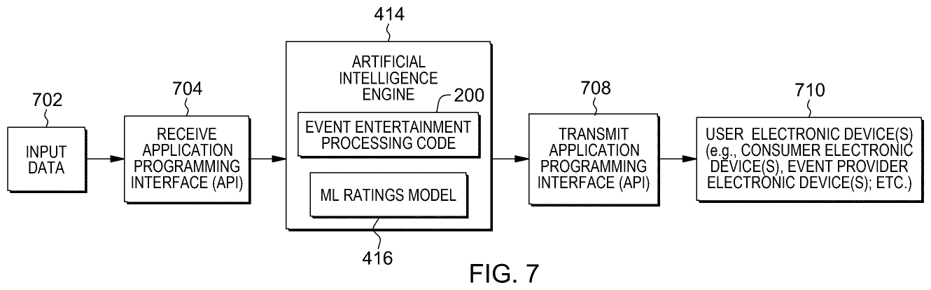

FIG. 7 depicts a further example of a computing environment to incorporate, use or implement, one or more aspects of an embodiment of the present disclosure, and which can be implemented as part of, or include, a computing environment such as computing environment 100 described above in connection with FIG. 1 and/or computing environment 400 described above in connection with FIG. 4. As illustrated, in one or more embodiments, input data 702 can be obtained from one or more data sources, such as described above in connection with FIG. 4. For instance, in one or more embodiments, the input data can be obtained from one or more external trusted sources to gather live insights on the live events, such as live scores, goals scored, player ratings during the event, etc., where any of these values can change, during the event. The input data is received, in one embodiment, via a receive application programming interface 704. For instance, in one or more embodiments, the receive application programming interface 704 can be a live data receive application programming interface used to forward or push the latest real-time event-related data. For example, should a team in a live event make a substitution, it could affect the current average participant rating for the team within the event.

In one or more embodiments, the input data is pushed to one or more artificial intelligence engines 414 of an artificial intelligence system (e.g., artificial intelligence system 401 of FIG. 4) that executes or includes one or more aspects of event entertainment processing code 200 (and/or event entertainment process 300), such as disclosed herein. In one or more embodiments, event entertainment processing code 200 trains, or includes, and/or utilizes, one or more machine learning ratings models 416, which can be part of event entertainment processing code 200 or accessed by event entertainment processing code 200. In one or more embodiments, artificial intelligence engine 414 facilitates training the machine learning model(s) 416, such as the machine learning ratings model, using event-related data to facilitate predicting entertainment value ratings for live events to be provided across one or more networks, where the event-related data includes, for instance, different event-related data types, such as described herein. As noted, in one or more embodiments, artificial intelligence engine 414 obtains collection-related data, where the collection-related data includes event-related data for the live events for a collection of live events overlapping, at least in part, in time. In one or more embodiments, the artificial intelligence engine 414 executes the machine learning ratings model using the collection-related data to predict respective entertainment value ratings for the live events of the collection of live events. For instance, in one or more embodiments, the machine learning ratings model can be executed periodically, such as every minute, as additional real-time (live) event-related data is received via the receive application programming interface 704. In one or more embodiments, artificial intelligence engine 414, and in particular, event entertainment processing code 200, generates from the predicted respective entertainment value ratings for the live events of the collection of live events an event entertainment notification, such as a ranking of the live events of the collection of live events, which is then transmitted, for instance, via one or more transmit application programming interfaces (APIs) 708 to one or more electronic devices of one or more users 710 (e.g., consumer electronic device(s), event provider electronic device(s), etc.) to facilitating initiating one or more actions based thereon, such as described herein. For instance, in one or more embodiments, when the respective entertainment value ratings for the live events of the collection of live events are updated, the ratings and/or ranking can be pushed to the registered users (e.g., consumers, providers, etc.).

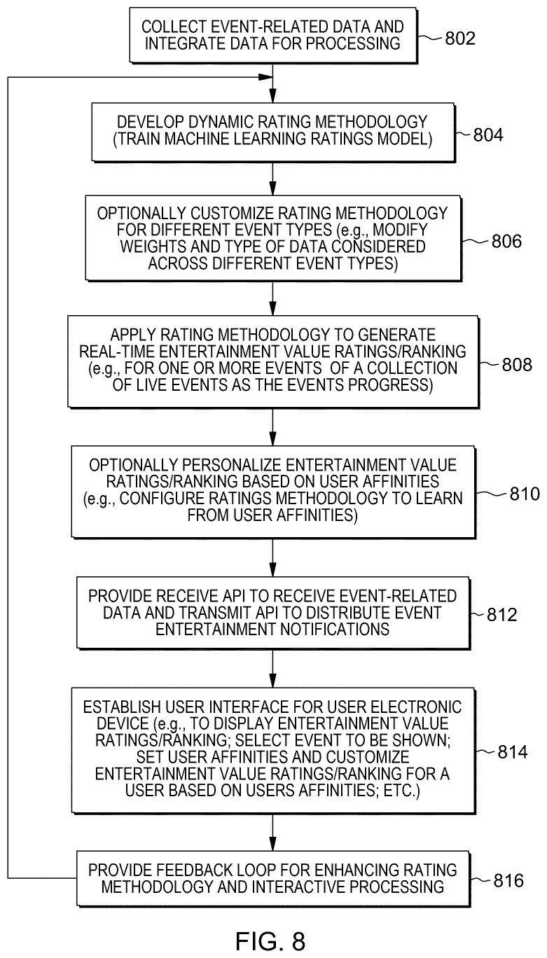

FIG. 8 depicts a further embodiment of an event entertainment process workflow, in accordance with one or more aspects of the present disclosure. In one or more embodiments, event entertainment processing code is used, in accordance with one or more aspects of the present disclosure, to perform event entertainment processing such as depicted in FIG. 8. The process can be executed, in one or more embodiments, by a computer (e.g., computer 101 (FIG. 1), computer resource(s) 410 (FIG. 4)), and/or one or more processor sets, such as a processor or processing circuitry (e.g., of processor set 110 of FIG. 1). In one example, code or instructions implementing the process, are part of a code or module, such as an event entertainment processing code, such as event entertainment processing code 200 described herein by way of example. In another example, the code can be included in one or more other modules and/or one or more other sub-modules of one or more other modules. Various options are available.

As illustrated in FIG. 8, the event entertainment process can include collecting event-related data and integrating the data for processing 802. For instance, in one or more embodiments, real-time data or live data can be collected for various live events (e.g., live sporting events) including, for instance, team rankings, player performance, recent scores, goals scored, rivalry history, etc., as described herein. In one or more embodiments, application programing interfaces can be used to continuously obtain or fetch an update of the event-related data in real-time. In one or more embodiments, a dynamic rating methodology can be developed, including, for instance, training one or more machine learning ratings models 804, such as described. In one or more embodiments, the dynamic rating methodology assesses the entertainment value of a live event based on the collected event-related data. Further, in one or more embodiments, weights can be assigned to different types of event-related data based, for instance, on their predictive impact on the live event's entertainment value. For instance, closer team rankings or historic rivalries can be given more weight.

Optionally, the ratings methodology can be customized for different event types 806. For instance, in one or more embodiments, the process can include modifying weights and/or type of data considered across different event types. For instance, in one sporting event, goals scored may be highly weighted, while in another sporting event, player performance metrics might be more important to rating entertainment value of the event.

As illustrated, in one or more embodiments, the process includes applying the rating methodology to generate real-time entertainment value ratings and/or rankings 808. For instance, in one or more embodiments, the ratings and/or rankings can be generated for one or more live events for a collection of live events as the events progress. For example, in one or more embodiments, depending on the event type, the respective entertainment value ratings and/or rankings can be updated based on, for instance, goals scored, substitutions, or other changes in player's performance, etc., during the live event. In this manner, the event-related data is dynamically updated and the respective entertainment value ratings and/or rankings are updated in real-time as well.

In embodiments, the process further includes optionally personalizing the entertainment value ratings and/or rankings based on user affinities, such as described herein. For instance, in one or more embodiments, the dynamic rating methodology used by the artificial intelligence system can be configured to learn from user affinities 810. In this manner, the artificial intelligence system tailors the respective entertainment value ratings or rankings based on user affinities (e.g., preferences, viewing history, etc.), which can be used to tailor or personalize the event entertainment notifications (e.g., recommendations, entertainment value ratings, etc.) based on the user affinities.

In one or more embodiments, the process further includes providing a receive application programing interface (receive API) to receive event-related data, such as real-time event-related data, and a transmit application program interface (transmit API) to distribute event entertainment notifications, such as respective event entertainment value ratings and/or one or more rankings based on the entertainment value ratings of the live events of the collection of live events 812. In this manner, the dynamic rating methodology ensures that the ratings and/or rankings are pushed immediately after each respective entertainment value ratings update for real-time relevance of the event entertainment notifications.

In one or more embodiments, the process further includes establishing a user interface for the user electronic device 814. For instance, the user interface (e.g., graphical user interface) can be configured to display the entertainment value ratings or ranking, the entertainment value notification, or the selected event to be shown, and/or to set user affinities, and customize entertainment value ratings/rankings for a user based on user affinities, to provide feedback data on one or more event entertainment notifications, and/or to facilitate initiating an action based thereon. Note that, in one or more embodiments, different users to receive the event entertainment notification can be configured with the same or different user interfaces. Further, note that the user interface provided can include options for a user to set preferences (i.e. affinities) and filter events or games based on their particular interest. As noted herein, in one or more embodiments, the use of user affinities can be in association with the users registering with the system, including each user authorizing the system to collect the user-related data for personalizing the notifications, such as described herein.

In one or more embodiments, the process can further include providing a feedback loop for enhancing the rating methodology and providing interactive processing 816. For instance, in one or more embodiments, the feedback loop or system can allow users to rate the entertainment experience, thereby allowing the user's feedback data to be used in retraining the machine learning ratings model, and/or in executing the machine learning ratings model to allow for a recalculation or recalibration of the model based on the feedback data. In this manner, the methodology can be continuously refined to improve accuracy over time based, in part, on the feedback data. Further, in one or more embodiments, the feedback data can be saved in a historical knowledge corpus or data store that supports the training and executing of the machine learning ratings model, and the other methodologies disclosed.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
training a machine learning ratings model using event-related data to predict entertainment value ratings for live events to be provided across one or more networks, the event-related data including in part different event-related data types;
identifying, by an artificial intelligence system, a collection of live events overlapping, at least in part, in time;
obtaining collection-related data, the collection-related data comprising event-related data for the live events of the collection of live events;
executing, by the artificial intelligence system, the machine learning ratings model using the collection-related data to predict respective entertainment value ratings for the live events of the collection of live events;
generating, by the artificial intelligence system, an event entertainment notification for the collection of live events based on the respective entertainment value ratings; and
transmitting, via one or more application programming interfaces, the event entertainment notification for the live events of the collection of live events to an electronic device of a user to facilitate initiating an action based thereon.

2. The method of claim 1 further comprising:
obtaining real-time event-related data for one or more live events of the collection of live events during occurrence of the one or more live events;
dynamically modifying one or more of the respective entertainment value ratings and generating an updated event entertainment notification for the live events of the collection of live events during occurrence of the one or more live events of the collection of live events, the dynamically modifying one or more respective entertainment value ratings including re-executing, via the artificial intelligence system, the machine learning ratings model using the real-time event-related data to predict updated respective entertainment value ratings for the one or more live events of the collection of live events, and the generating the updated event entertainment notification for the collection of live events including generating the updated event entertainment notification for the collection of live events based, at least in part, on the updated respective entertainment value ratings; and
transmitting, via the one or more application programming interfaces, the updated event entertainment notification for the collection of live events to the electronic device of the user.

3. The method of claim 2, further comprising:
continuously monitoring for further real-time event-related data for the one or more live events during occurrence of the one or more live events;
periodically dynamically modifying the updated respective entertainment value ratings, and selectively generating therefrom a further event entertainment notification for the collection of live events during occurrence of the one or more live events; and
transmitting, via the one or more application programming interfaces, the further event entertainment notification for the collection of the live events to the electronic device of the user.

4. The method of claim 2, wherein the collection of live events is a collection of live games, and wherein obtaining the collection-related data comprises obtaining participant-related data for participants of the live events of the collection of live events, and obtaining the real-time event-related data for the one or more live events of the collection of live events comprises obtaining real-time participant-related data for the one or more live events of the collection of live events during occurrence of the one or more live events.

5. The method of claim 2, wherein the collection of live events is a collection of live games, and wherein obtaining the collection-related data comprises obtaining two or more of participant-related data, game-related data, team-related data, rivalry-related data, standings-related data or trend-related data for the live events of the collection of live events, and obtaining the real-time event-related data for the one or more live events of the collection of live events comprises obtaining real-time updates for one or more of the participant-related data, game-related data, team-related data, rivalry-related data, standings-related data or trend-related data for the one or more live events of the collection of live events during occurrence of the one or more live events.

6. The method of claim 1, further comprising:
registering the user with the artificial intelligence system to receive a personalized event entertainment notification;
based on the registering, obtaining by the artificial intelligence system user-affinity-related data representative of one or more user affinities related to the live events of the collection of live events; and
wherein training the machine learning ratings model comprises training the machine learning ratings model in part using the user-affinity-related data to predict entertainment value ratings for the live events based on the one or more user affinities, and the event entertainment notification for the collection of live events is the personalized event entertainment notification for the user for the collection of live events based in part on the one or more user affinities.

7. The method of claim 1, wherein training the machine learning ratings model using the event-related data includes assigning weights to the different event-related data types based on predicted impact of the different event-related data types on entertainment value of the live events.

8. The method of claim 7, wherein training the machine learning ratings model further comprises training the machine learning ratings model for different types of live events to be provided across the one or more networks, the training including customizing assigned weights to the different event-related data types based on predicted impact of the different event-related data types on entertainment value on the respective types of live events.

9. The method of claim 1, further comprising receiving, by the artificial intelligence system, feedback data related to the event entertainment notification for the collection of live events, and wherein the method further comprises retraining the machine learning ratings model, at least in part, using the feedback data.

10. A computer program product comprising:
one or more computer readable storage media; and
program instructions stored on the one or more computer readable storage media to perform operations comprising:
training a machine learning ratings model using event-related data to predict entertainment value ratings for live events to be provided across one or more networks, the event-related data including in part different event-related data types;
identifying a collection of live events overlapping, at least in part, in time;
obtaining collection-related data, the collection-related data comprising event-related data for the live events of the collection of live events;
executing the machine learning ratings model using the collection-related data to predict respective entertainment value ratings for the live events of the collection of live events;
generating an event entertainment notification for the collection of live events based on the respective entertainment value ratings; and
transmitting, via one or more application programming interfaces, the event entertainment notification for the live events of the collection of live events to an electronic device of a user to facilitate initiating an action based thereon.

11. The computer program product of claim 10, wherein the operations further comprise:
obtaining real-time event-related data for one or more live events of the collection of live events during occurrence of the one or more live events;
dynamically modifying one or more of the respective entertainment value ratings and generating an updated event entertainment notification for the live events of the collection of live events during occurrence of the one or more live events of the collection of live events, the dynamically modifying one or more respective entertainment value ratings including re-executing, via the artificial intelligence system, the machine learning ratings model using the real-time event-related data to predict updated respective entertainment value ratings for the one or more live events of the collection of live events, and the generating the updated event entertainment notification for the collection of live events including generating the updated event entertainment notification for the collection of live events based, at least in part, on the updated respective entertainment value ratings; and
transmitting, via the one or more application programming interfaces, the updated event entertainment notification for the collection of live events to the electronic device of the user.

12. The computer program product of claim 11, wherein the collection of live events is a collection of live games, and wherein obtaining the collection-related data comprises obtaining two or more of participant-related data, game-related data, team-related data, rivalry-related data, standings-related data or trend-related data for the live events of the collection of live events, and obtaining the real-time event-related data for the one or more live events of the collection of live events comprises obtaining real-time updates for one or more of the participant-related data, game-related data, team-related data, rivalry-related data, standings-related data or trend-related data for the one or more live events of the collection of live events during occurrence of the one or more live events.

13. The computer program product of claim 10, wherein the operations further comprise:
registering the user with the artificial intelligence system to receive a personalized event entertainment notification;
based on the registering, obtaining by the artificial intelligence system user-affinity-related data representative of one or more user affinities related to the live events of the collection of live events; and
wherein training the machine learning ratings model comprises training the machine learning ratings model in part using the user-affinity-related data to predict entertainment value ratings for the live events based on the one or more user affinities, and the event entertainment notification for the collection of live events is the personalized event entertainment notification for the user for the collection of live events based in part on the one or more user affinities.

14. The computer program product of claim 10, wherein training the machine learning ratings model using the event-related data includes assigning weights to the different event-related data types based on predicted impact of the different event-related data types on entertainment value of the live events.

15. The computer program product of claim 14, wherein training the machine learning ratings model further comprises training the machine learning ratings model for different types of live events to be provided across the one or more networks, the training including customizing assigned weights to the different event-related data types based on predicted impact of the different event-related data types on entertainment value on the respective types of live events.

16. The computer program product of claim 10, wherein the operations further comprise receiving, by the artificial intelligence system, feedback data related to the event entertainment notification for the collection of live events, and wherein the method further comprises retraining the machine learning ratings model, at least in part, using the feedback data.

17. A computer system comprising:
a processor set;
one or more computer-readable storage media; and
program instructions stored on the one or more computer-readable storage media to cause the processor set to perform operations comprising:
training a machine learning ratings model using event-related data to predict entertainment value ratings for live events to be provided across one or more networks, the event-related data including in part different event-related data types;
identifying a collection of live events overlapping, at least in part, in time;
obtaining collection-related data, the collection-related data comprising event-related data for the live events of the collection of live events;
executing the machine learning ratings model using the collection-related data to predict respective entertainment value ratings for the live events of the collection of live events;
generating an event entertainment notification for the collection of live events based on the respective entertainment value ratings; and
transmitting, via one or more application programming interfaces, the event entertainment notification for the live events of the collection of live events to an electronic device of a user to facilitate initiating an action based thereon.

18. The computer system of claim 17, wherein the operations further comprise:
obtaining real-time event-related data for one or more live events of the collection of live events during occurrence of the one or more live events;
dynamically modifying one or more of the respective entertainment value ratings and generating an updated event entertainment notification for the live events of the collection of live events during occurrence of the one or more live events of the collection of live events, the dynamically modifying one or more respective entertainment value ratings including re-executing, via the artificial intelligence system, the machine learning ratings model using the real-time event-related data to predict updated respective entertainment value ratings for the one or more live events of the collection of live events, and the generating the updated event entertainment notification for the collection of live events including generating the updated event entertainment notification for the collection of live events based, at least in part, on the updated respective entertainment value ratings; and
transmitting, via the one or more application programming interfaces, the updated event entertainment notification for the collection of live events to the electronic device of the user.

19. The computer system of claim 18, wherein the collection of live events is a collection of live games, and wherein obtaining the collection-related data comprises obtaining two or more of participant-related data, game-related data, team-related data, rivalry-related data, standings-related data or trend-related data for the live events of the collection of live events, and obtaining the real-time event-related data for the one or more live events of the collection of live events comprises obtaining real-time updates for one or more of the participant-related data, game-related data, team-related data, rivalry-related data, standings-related data or trend-related data for the one or more live events of the collection of live events during occurrence of the one or more live events.

20. The computer system of claim 17, wherein the operations further comprise:
registering the user with the artificial intelligence system to receive a personalized event entertainment notification;
based on the registering, obtaining by the artificial intelligence system user-affinity-related data representative of one or more user affinities related to the live events of the collection of live events; and
wherein training the machine learning ratings model comprises training the machine learning ratings model in part using the user-affinity-related data to predict entertainment value ratings for the live events based on the one or more user affinities, the event entertainment notification for the collection of live events being the personalized event entertainment notification for the user for the collection of live events based in part on the one or more user affinities.
